(19) United States
(12) Patent Application Publication
(10) Pub. No.: US 2009/0184031 A1
(43) Pub. Date: Jul. 23, 2009

(54) APPARATUS AND SYSTEM FOR SIFTING

(76) Inventor: Edward OLIWA, Lake Wylie, SC (US)

Correspondence Address: HAMMER & ASSOCIATES, P.C., 3125 SPRINGBANK LANE, SUITE G, CHARLOTTE, NC, 28226, US

(21) Appl. No.: 12/017,076

(22) Filed: Jan. 21, 2008

(51) Int. Cl. B07B 1/00

(52) U.S. Cl. 209/236

(57) ABSTRACT

A sieve includes a rectangular reservoir that has a screen bottom. The sieve also includes a first side flange that is positioned on one side of the reservoir and a second side flange that is positioned on the opposite side of the reservoir. The reservoir is adapted to fit within a container where the two side flanges extend over and rest on opposite sides of the container. The reservoir is movable within the container, whereby, when the powdered substance is inserted into the sieve, the sieve sifts the reusable powdered substance from the non-reusable powdered substance.

### FIELD OF INVENTION

The instant application relates to a system and apparatus for sifting. The system and apparatus is for particular use in the restaurant industry.

### BACKGROUND OF THE INVENTION

A sieve, or sifter, is a device used to separate wanted/desired elements from unwanted material using a tool such as a screen, mesh, net or other filtration or distillation method. One particular type of sieve is used in the restaurant industry when preparing foods. Some foods are prepared by coating them with flour, corn meal, breading, baking powder, seasonings and mixtures thereof, or any powdered substance of the like.

In order to carry out this coating process, the food is either submerged in the powdered substance or the powdered substance is dumped onto the food. A sieve is then used to separate the reusable powdered substance from the non-reusable powered substance in order to recycle the powdered substance to be used again. The non-reusable powdered substance includes any of the powdered substance that is not reusable, for example, the powered substance is not reusable if it has clumped together due to moisture from the food.

During some food preparation, the food is first coated with the powdered substance, for example, in a bus pan or paper bag. Next, the sieve is placed over an empty container, and the powdered substance that has not been coated on the food is dumped onto the sieve. The circular sieve is then shaken over the empty container where the operator of the sieve attempts to force the reusable powdered substance to fall into the empty container, thereby separating it from the non-reusable powdered substance in the sieve. However, this process is very messy and wasteful as some of the powdered substance typically falls outside of the container.

In the restaurant industry, the process of coating foods becomes even messier and more wasteful where cooks have the task of preparing large amounts of food in a short amount of time. The common use in the restaurant industry is to use a large circular sieve and a rectangular bus pan as the container to sift the reusable powdered substance into. Sifting the reusable powdered substance from a large circular sieve to a rectangular bus pan can be very difficult. In addition, due to the time constraints and other various reasons, cooks in restaurants are not as cautious when trying to shake the circular sieve where the reusable powdered substance will fall into the rectangular bus pan. Furthermore, because a cook in the restaurant industry typically attempts to coat large amounts of food at one time, the large amounts of powdered substance can make the circular sieve become very heavy and difficult to operate. This further adds to the problem of the mess and waste caused by trying to shake the sieve where the reusable powdered substance will fall into the empty container or rectangular bus pan.

The instant invention is designed to address the above mentioned problems.

### SUMMARY OF THE INVENTION

The instant invention is a sieve. The sieve includes a rectangular reservoir. The rectangular reservoir has a screen bottom. The sieve also includes a first side flange being positioned on one side of the reservoir and a second side flange being positioned on the opposite side of the reservoir. The reservoir is adapted to fit within a container where the two side flanges extend over and rest on opposite sides of the container. The reservoir is movable within the container, whereby, when the powdered substance is inserted into the sieve, the sieve sifts the reusable powdered substance from the non-reusable powdered substance.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a segmented perspective view of one embodiment of the system for sifting the reusable powdered substance from the non-reusable powdered substance.

FIG. 2 is a perspective view of the embodiment of the system from FIG. 1 for sifting the reusable powdered substance from the non-reusable powdered substance.

FIG. 3 is a perspective view of another embodiment of the system for sifting the reusable powdered substance from the non-reusable powdered substance.

### DETAILED DESCRIPTION OF THE INVENTION

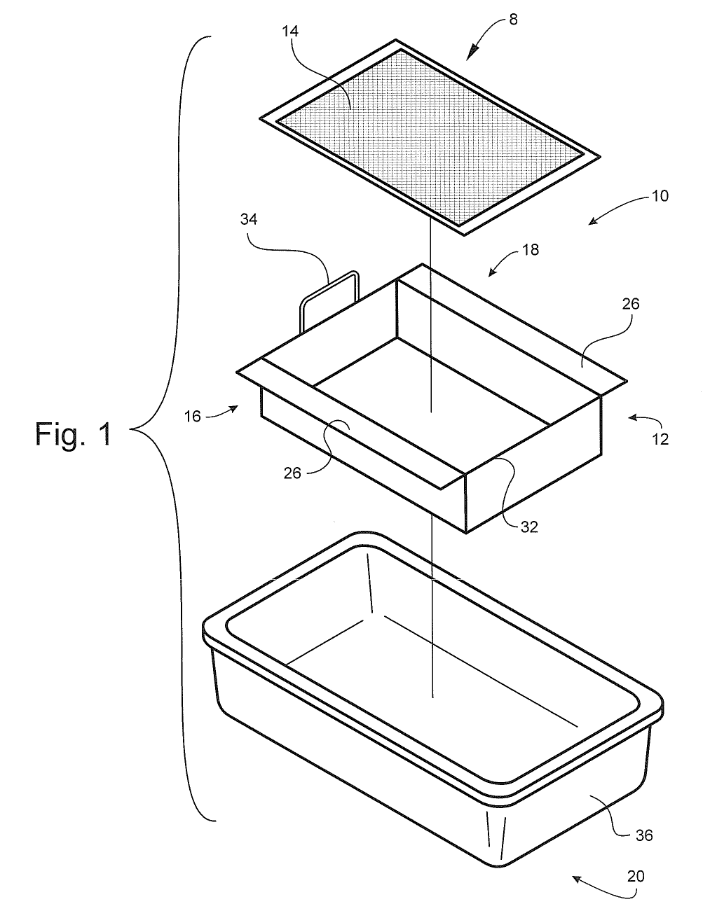

Referring to the drawings, wherein like numerals indicate like elements, there is shown in FIG. 1 an embodiment of a system 8 for sifting the reusable powdered substance from the non-reusable powdered substance. System 8 may include a sieve 10 and a container 20.

For purposes herein, the term “powdered substance” is any substance capable of being sifted. A powdered substance may include, but is not limited to, any substance used to coat or season food, like, flour, corn meal, breading, baking powder, seasonings and/or mixtures thereof, and any substance of the like. The term “non-reusable” powdered substance includes any of the powdered substance that is not “reusable”, for example, the powdered substance is not reusable if it has clumped together due to moisture from the food.

Sieve 10 may be included in system 8 for coating food with a powdered substance and sifting the reusable powdered substance from the non-reusable powdered substance. Sieve 10 may be for sifting the reusable powdered substance from the non-reusable powdered substance (see FIGS. 1-3). Sieve 10 may include any apparatus capable of sifting the reusable powdered substance from the non-reusable powdered substance. Sieve 10 may include a reservoir 12, a screen bottom 14, a first side flange 16, and a second side flange 18. Sieve 10 may also include a handle 34. Sieve 10 may be adapted to fit within container 20. Sieve 10 may be movable within container 20 in any direction, including, but not limited to, a second direction 22 that is approximately perpendicular to a first direction 21 that side flanges 16 and 18 are oriented in, which may be approximately opposite of one another from reservoir 12.

Reservoir 12 may be included in sieve 10 (see FIGS. 1-3). Reservoir 12 may be for providing a space for sifting the reusable powdered substance from the non-reusable powdered substance. Reservoir 12 may be any device capable of providing a space for sifting the reusable powdered substance from the non-reusable powdered substance. Reservoir 12 may be any shape, including, but not limited to, rectangular or circular. Reservoir 12 may be made of any material, including but not limited to, stainless steel. Reservoir 12 may have a screen bottom 14. Reservoir 12 may also have, attached to it or integrally built with it, first side flange 16 and second side flange 18. Side flanges 16 and 18 may be oriented approximately opposite of one another in first direction 21 from the outsides of reservoir 12. Reservoir 12 may be any size. The size of reservoir 12 may depend on the size of container 20. For example, for use with a 26 inch by 18 inch bus pan, reservoir 12 may be approximately 15 inches by 18 inches, thereby allowing reservoir 12 to move back and forth in the 26 inch by 18 inch bus pan.

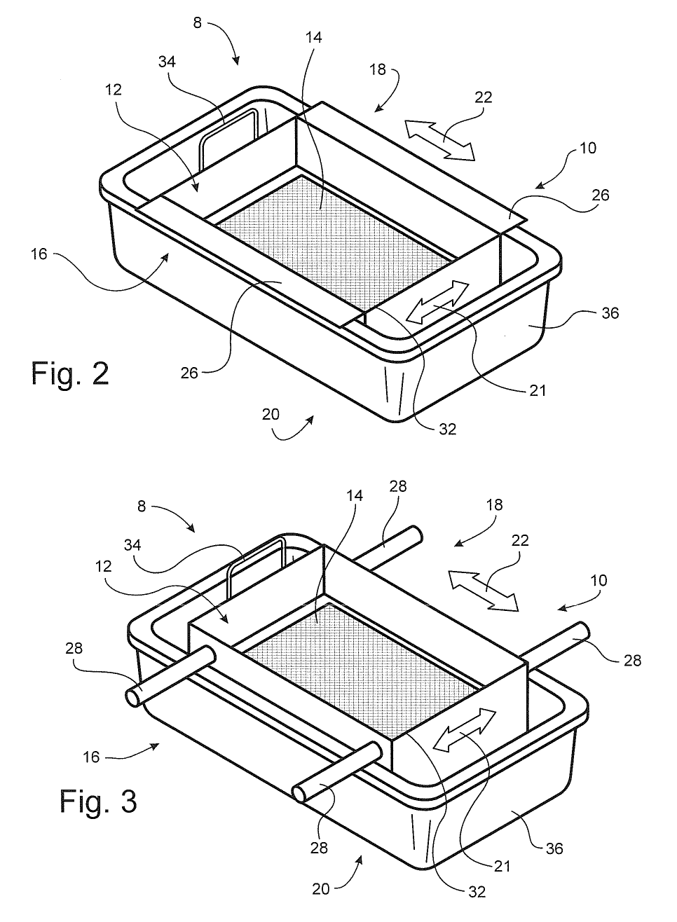

First side flange 16 and second side flange 18 may be included in sieve 10 (see FIGS. 1-3). First side flange 16 and second side flange 18 may be for providing support for sieve 10 to rest on opposite sides of container 20 and move within container 20. First side flange 16 and second side flange 18 may be any devices capable of providing support for sieve 10 to rest on opposite sides of container 20 and move within container 20. First side flange 16 and second side flange 18 may be any length, including, but not limited to, just long enough to extend over and rest on the sides of reservoir 12. First side flange 16 may extend out from one side of reservoir 12 and second side flange 18 may extend out from the opposite side of reservoir 12. First side flange 16 and second side flange 18 may be oriented in any direction from reservoir 12, including, but not limited to, in first direction 21 approximately opposite of one another. The two side flanges 16 and 18 may be positioned anywhere on sieve 10, including but not limited to, in the middle of reservoir 12 or near rim 32 of reservoir 12. Sieve 10 may include just first and second side flanges 16 and 18 (see FIGS. 1-2), or sieve 10 may include more than one side flange on one or opposite sides of reservoir 12 (see FIG. 3). The side flanges may be any shape, including but not limited to, a flat shape (see FIGS. 1-2) or a cylindrical shape (see FIG. 3), or a combination of the two. The side flanges 16 and 18 may be a flat bar 26 that extends approximate the length of the side of reservoir 12 (see FIGS. 1-2), or cylindrical shape 28 (see FIG. 3).

Screen bottom 14 may be included as the bottom of reservoir 12 (see FIGS. 1-3). Screen bottom 14 may be for sifting the reusable powdered substance out of the bottom of reservoir 12 to separate it from the non-reusable powdered substance. Screen bottom 14 may be anything capable of sifting the reusable powdered substance out of the bottom of reservoir 12, including, but not limited to a screen, a mesh, a net, or any other filtration device. Screen bottom 14 may be made of any material, including, but not limited to, stainless steel. Screen bottom 14 may be included as a permanent part of the bottom of reservoir 12 or may be removable (see FIG. 1). Screen bottom 14 may be removable by any means, including but not limited to, being able to be lifted out of reservoir 12 or being able to slide out of reservoir 12. Screen bottom 14 may slide out of reservoir 12 in any direction, including, in first direction 21, which may prevent screen bottom 14 from unintentionally sliding out of place while sieve 10 moves in second direction 22.

Handle 34 may also be included in sieve 10 (see FIGS. 1-3). Handle 34 may be for providing a place to operate and carry sieve 10. Handle 34 may be any device for providing a place to move sieve 10 back and forth within container 20 and/or for providing a place to carry sieve 10. Handle 34 may be built into the walls of reservoir 12 or may be added to reservoir 12. Handle 34 may be positioned anywhere on sieve 10, including, but not limited to, on one of the ends of reservoir 12. Sieve 10 may include a single handle 34 or may include more than one handle 34. Handle 34 may be any shape or size.

Container 20 may be included in system 8 for sifting the reusable powdered substance from the non-reusable powdered substance (see FIGS. 1-3). Container 20 may be for collecting and holding the reusable powdered substance sifted from sieve 10. Container 20 may be any device capable of collecting and holding the reusable powdered substance sifted from sieve 10. Container 20 may be made of any material, including but not limited to, a plastic. Container 20 may be any shape, including but not limited to, rectangular. Container 20 may be a bus pan 36. Bus pan 36 may be any conventional bus pan used in the restaurant industry. Bus pan 36 may be any size, including but not limited to, a commonly used 26 inch by 18 inch bus pan, or a commonly used 13.5 inch by 17 inch bus pan.

In operation, a method of sifting the reusable powdered substance (like flour) from the non-reusable powdered substance may be utilized with system 8. Empty Sieve 10 may first be inserted and positioned within a relatively empty reservoir 12 where side flanges 16 and 18 fit over and rest on opposite sides of reservoir 12. The powdered substance may first be used to coat the food, by for example, pouring the powdered substance onto the food within a bus pan (or the like) or shaking the food within a paper bag (or the like) partly filled with the powdered substance. Next, the powdered substance that is not coated on the food may then be placed into sieve 10. The powdered substance may be placed on screen bottom 14 within reservoir 12. Next, the reusable powdered substance can then be sifted from the non-reusable powdered substance out of screen bottom 14 by moving reservoir 12 back and forth within container 20. This process separates the reusable powdered substance (empties into reservoir 12) from the non-reusable powdered substance (still remains on screen bottom 14).

The present invention may be embodied in other forms without departing from the spirit and the essential attributes thereof, and, accordingly, reference should be made to the appended claims, rather than to the foregoing specification, as indicated in the scope of the invention.

I claim:

1. A sieve comprising:
a reservoir having a screen bottom; and
a first side flange being positioned on one side of said reservoir and a second side flange being positioned on the opposite side of said reservoir;
said reservoir being adapted to fit within a container where said side flanges extend over and rest on opposite sides of said container;
said reservoir being movable within said container, whereby, when the powdered substance being inserted into said sieve, said sieve sifting the reusable powdered substance from the non-reusable powdered substance.

2. The sieve of claim 1 where said two side flanges being oriented in a first direction being approximately opposite of one another from said reservoir, and said reservoir being movable within said container in a second direction approximately perpendicular to said first direction.

3. The sieve of claim 1 where said side flanges having a flat shape.

4. The sieve of claim 3 where said flat shaped side flanges being a flat bar extending approximately the length of the side of said reservoir.

5. The sieve of claim 1 where said side flanges having a cylindrical shape.

6. The sieve of claim 5 where said cylindrically shaped side flanges being cylinders extending from the center of the side of said reservoir.

7. The sieve of claim 1 having at least two side flanges on at least one side of said reservoir.

8. The sieve of claim 1 where said two side flanges being positioned approximate a rim of said reservoir.

9. The sieve of claim 1 where said screen bottom being removable.

10. The sieve of claim 9 where said screen bottom being removable from said reservoir by sliding out of said reservoir in said first direction.

11. The sieve of claim 1 further including a handle.

12. The sieve of claim 1 where said reservoir having a rectangular shape.

13. The sieve of claim 1 where said container having a rectangular shape.

14. A system for separating reusable powdered substance from non-reusable powdered substance comprising:
a sieve including:
a reservoir having a screen bottom; and
a first side flange being positioned on one side of said reservoir and a second side flange being positioned on the opposite side of said reservoir;
a container; and
a handle;
said reservoir being adapted to fit within said container where said first and second side flanges extend over and rest on opposite sides of said container;
said reservoir being movable within said container, whereby, when the powdered substance being inserted into said sieve, said sieve sifting the reusable powdered substance from the non-reusable powdered substance.

15. The system for separating reusable powdered substance from non-reusable powdered substance of claim 14 where said two side flanges being oriented in a first direction being approximately opposite of one another from said reservoir, and said reservoir being movable within said container in a second direction approximately perpendicular to said first direction.

16. The system for separating reusable powdered substance from non-reusable powdered substance of claim 14 where said first and second side flanges having a flat shape.

17. The system for separating reusable powdered substance from non-reusable powdered substance of claim 14 having at least two side flanges on at least one side of said reservoir.

18. The system for separating reusable powdered substance from non-reusable powdered substance of claim 14 where said reservoir having a rectangular shape.

19. The system for separating reusable powdered substance from non-reusable powdered substance of claim 14 where said container having a rectangular shape.

20. A method of sifting reusable powdered substance from non-reusable powdered substance comprising:
providing a sieve including:
a rectangular reservoir having a screen bottom; and
a first side flange being positioned on one side of said reservoir and a second side flange being positioned on the opposite side of said reservoir
providing a rectangular container;
said rectangular reservoir being adapted to fit within said rectangular container where said side flanges extend over and rest on opposite sides of said rectangular container and said rectangular reservoir being movable within said rectangular container;
inserting said rectangular reservoir into said container where said side flanges fitting over and resting on opposite sides of said container;
pouring the reusable and non-reusable powdered substance into said sieve; and
moving the rectangular reservoir back and forth within said container, thereby, sifting the reusable powdered substance from the non-reusable powdered substance.
